(19) United States
(12) Patent Application Publication
(10) Pub. No.: US 2014/0231301 A1
(43) Pub. Date: Aug. 21, 2014

(54) MEDICATION STORAGE SYSTEM, CONTAINER FOR MEDICATION, AND A METHOD OF PREPARING MEDICATION TO BE TAKEN BY AN INDIVIDUAL

(71) Applicants: Richard A. Herbert, Riverside, IL (US); Joyce Slabich, Riverside, IL (US)

(72) Inventors: Richard A. Herbert, Riverside, IL (US); Joyce Slabich, Riverside, IL (US)

(21) Appl. No.: 14/045,420

(22) Filed: Oct. 3, 2013

Related U.S. Application Data
(60) Provisional application No. 61/709,338, filed on Oct. 3, 2012.

(51) Int. Cl. A61J 1/03; A61J 3/00

(52) U.S. Cl. CPC A61J 1/03; A61J 3/007
USPC 206/534; 156/60

(57) ABSTRACT

A medication storage system having a container for a medication to be taken by an individual and information on the container to advise an individual at least one of: a) when to take medication in the container; b) how many doses of medication in the container are to be taken; and c) how to take medication in the container. The information includes at least one pictorial representation that visually conveys at least some of the information to the individual.

### BACKGROUND OF THE INVENTION

1. Field of the Invention

This invention relates to medication that is provided to individuals in a plurality of doses in a container.

2. Background Art

As modern medicine has advanced, polypharmacy for patients has increased dramatically over the past 30 years. Especially in the elderly it is not uncommon to find patients ingesting five to twenty-five or more doses of medications per day, often in divided doses of one to four times per day. Added to this may be as many as 5-30 vitamins/minerals and many over-the-counter (“OTC”) medicines. For purposes of the description and claims herein, “medication” is intended to encompass any prescribed or over-the-counter medication, vitamin, mineral, supplement, etc. that is supplied in a container in a quantity having multiple doses, with single or multiple doses represented by a predetermined amount of a flowable volume or a capsule/pill. Patients may be ingesting 10-60 or more individual doses per day in total.

The organizing of such ingestion, if left in the original containers, when the number of doses is so high, potentially becomes unwieldy. Each bottle must be closely looked at up to several times per day and several bottles may have to be examined each time a dose is due. This is likely to result in poor daily dosing compliance. In an attempt to make this task easier, there are several versions of plastic pill containers with compartments for each day of the week. But this solution itself has several major drawbacks. The size of each day compartment is often too small to contain all the daily doses. The doses, once in the compartment, cannot easily be determined as to when to take (morning, mid-day, night, bedtime, before/with/after meals, etc.). Should a container compartment accidentally spill—a frequent occurrence—a time-consuming mess may result. The act of physically transferring doses into the day compartments may take an inordinate amount of time, without even solving the aforementioned problems. A week or two of compartmentalizing doses in advance can take more than an hour and, again, does not solve the range of problems already mentioned.

Many patients, therefore, leave the pills in their original containers. But then, as mentioned, the patient must re-read bottles up to several times per day and the labels all come with small print—further complicating matters for elderly patients to get their medication doses correct. And considerable time is consumed in this process—perhaps over an hour per day. Because this process repeats daily, human nature tells us mistakes will be made and untoward results inevitably occur.

### SUMMARY OF THE INVENTION

In one form, the invention is directed to a medication storage system consisting of: a container for a medication to be taken by an individual; and information on the container to advise an individual at least one of: a) when to take medication in the container; b) how many doses of medication in the container are to be taken; and c) how to take medication in the container. The information consists of at least one pictorial representation that visually conveys at least some of the information to the individual.

In one form, the container has a top opening and a bottom wall. The information is provided on the bottom wall.

In one form, the container has a top opening and a closure for the top opening. The information is provided on the closure.

In one form, the information consists of one of words and abbreviations.

In one form, the invention is directed to a container for medication to be taken by an individual. The container consists of: a body defining a storage space for medication and having a bottom wall, a peripheral wall, and an opening for introducing medication into the storage space and removing medication from the storage space; a closure that is changed between a closed position wherein the closure blocks the opening and an open position wherein medications can be directed through the opening into and from the storage space; and information provided on at least one of the bottom wall and closure to advise an individual at least one of: a) when to take medication in the container; b) how many doses of medication in the container are to be taken; and c) how to take medication in the container.

In one form, the information consists of at least one pictorial representation that visually conveys at least some of the information to the individual.

In one form, the invention is further directed to a method of preparing medication to be taken by an individual. The method includes the steps of: providing first and second containers respectively having first and second bodies defining first and second storage spaces within which first and second different medications are placed; obtaining access to a supply of labels having generic information thereon to advise an individual at least one of: a) when to take medication in the container; b) how many doses of medication in the container are to be taken; and c) how to take medication in the container, the supply of labels including a first label wherein the generic information thereon is applicable to taking of the first medication by the individual and is different than the generic information on a second label in the supply of labels that is applicable to taking of the second medication by the individual; placing the first label on the first container; and placing the second label on the second container.

In one form, the method of preparing medication to be taken by an individual further includes the step of placing non-generic information relating to the first medication on the first container in addition to the generic information on the first label.

In one form, the generic information on the first label and the non-generic information on the first container each consists of letters making up at least one of words and abbreviations. The letters in the generic information on the first label are larger than the letters making up the non-generic information on the first container.

In one form, the step of placing the first label on the first container involves applying the first label through an adhesive.

In one form, the step of placing the first label on the first container involves applying the first label through a pressure sensitive adhesive.

### BRIEF DESCRIPTION OF THE DRAWINGS

FIG. 1 is a side elevation view of one form of conventional container for medications and consisting of a body and a repositionable closure/cap;

FIG. 2 is a perspective view of the body on the container in FIG. 1;

FIG. 3 is a view as in FIG. 2 from a different perspective;

FIG. 4 is a schematic representation of a conventional container as in FIGS. 1-3;

FIG. 5 is a plan view of a conventional container for multiple medications sorted by day;

FIGS. 6 and 7 are views as in FIG. 5 of further modified forms of prior art containers including “AM” and “PM” designations, respectively;

FIG. 8 is a partially schematic, side elevation view of a container for medication, according to the present invention;

FIG. 9 is a perspective view of the body on the container in FIG. 8;

FIG. 10 is a plan view of a plurality of containers as in FIGS. 8 and 9 with generic information applied according to the invention on the closure/cap;

FIG. 11 is a bottom view of a plurality of containers, according to the present invention, with generic information provided on the bottom wall thereof;

FIG. 12 is a flow diagram representation of a method of preparing medication to be taken by an individual, according to the invention;

FIG. 13 is a plan view of one form of a series of labels used to place information on containers, according to the invention;

FIG. 14 is a plan view of a modified form of label, according to the invention; and

FIG. 15 is a view as in FIG. 13, showing a further modified form of a series of labels, according to the invention.

### DETAILED DESCRIPTION OF THE PREFERRED EMBODIMENT

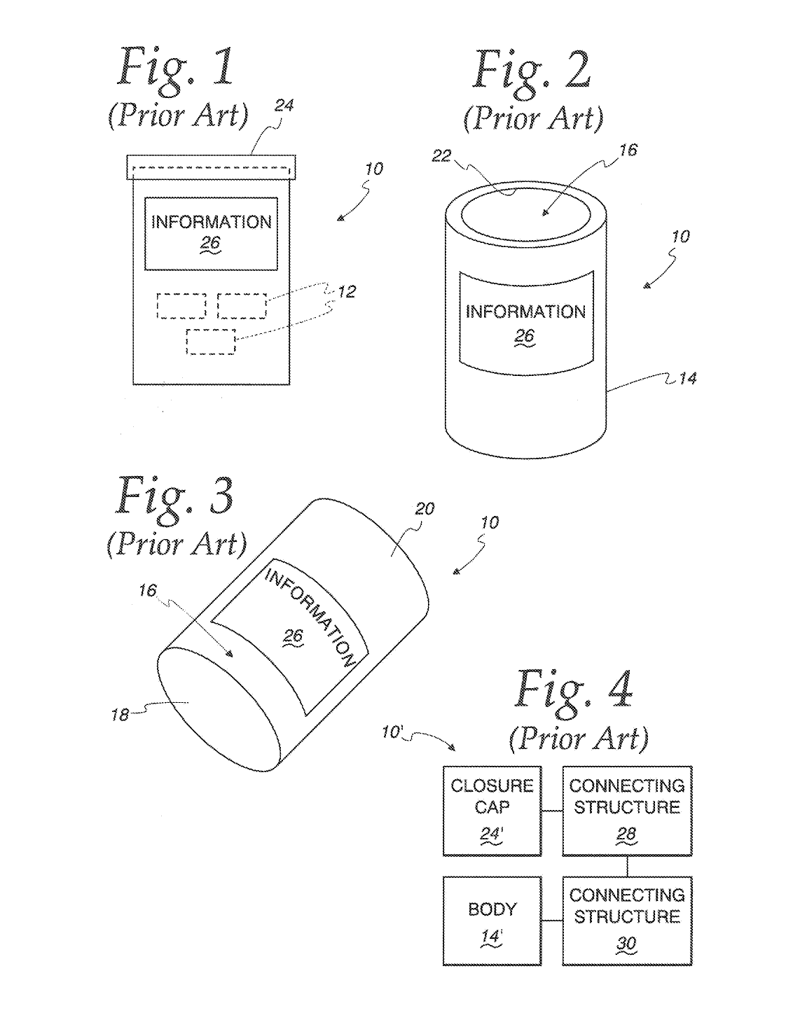

In FIGS. 1-3, a prior art container is shown at 10 for medication 12 to be taken by an individual. The container 10 consists of a body 14 defining a storage space 16 for the medication 12. The medication 12 may be in the form of a capsule/pill, as depicted, or in the form of a flowable material, that may be in liquid or particulate form. Regardless of the form of the medication 12, it is contemplated that the medication 12 be provided in the storage space 16 in a quantity representing multiple “doses”.

The body 14 has a bottom wall 18 and a peripheral wall 20. An opening 22, in this case at the top of the body 14, but not limited in terms of its location, is provided for introducing the medication 12 into the storage space 16 and removing the medication 12 from the storage space 16. A closure/cap 24 is changeable between a closed position, as shown in FIG. 1, wherein the closure/cap 24 blocks the opening 22, and an open position, as shown in FIGS. 2 and 3, wherein the medication 12 can be directed through the opening 22 into and from the storage space 16.

Information 26 is provided on the body 14 on the peripheral wall 20 thereof to advise the patient of the identity of the medication 12 and additionally provide other information that is at least one of: a) an indication as to when to take the medication 12 in the container 10; b) an indication of how many doses of medication 12 in the container 10 are to be taken, and c) an indication of how to take the medication 12 in the container 10. The information 26 typically includes words and/or abbreviations that are typed using a single font.

The invention is designed for use in conjunction with the container 10, and more particularly to a generic form thereof, as indicated in FIG. 4 at 10′. The container 10′ consists of a closure/cap 24′ that is changeable between closed and open positions relative to a body 14′. The closure/cap 24′ and body 14′ respectively have connecting structure 28, 30 that cooperate to allow the closure/cap 24′ and body 14′ to be relatively repositioned to change the state of the container 10′ for either confining or allowing introduction/removal of medication therefrom.

As described above, the individual taking the medication 12 will rely upon the information 26 to determine at least one of: a) when to take medication in the container; b) how many doses of medication in the container are to be taken; and c) how to take medication in the container. Accordingly, the individual, in the case of the container 10, will separate the closure/cap 24 at the appropriate time and follow the instructions that make up the information 26 to take the appropriate dosage in the appropriate manner.

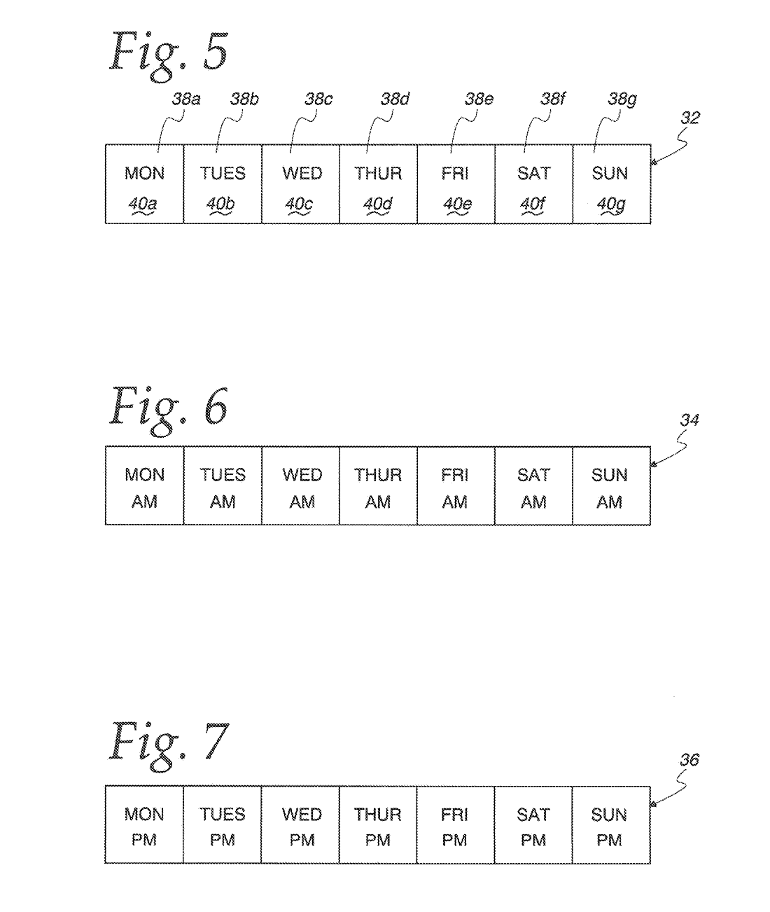

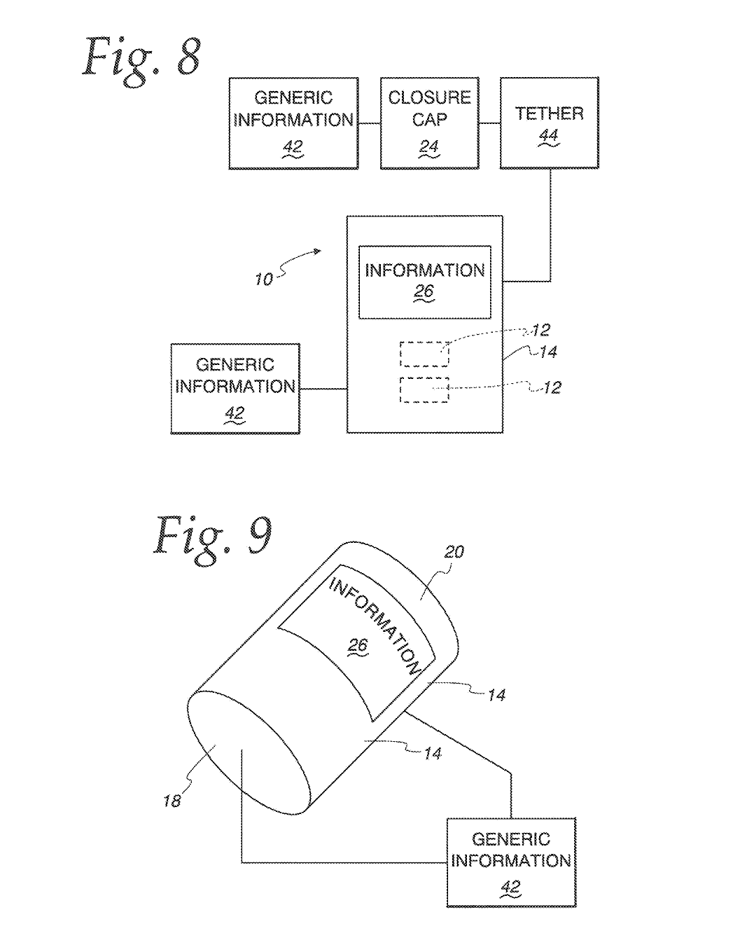

As an alternative to taking the medication 12 directly from the container 10 provided by the pharmacy or other supply location, it is common to transfer the medication 12 into labelled containers as shown at 32, 34, and 36 successively in FIGS. 5-7.

The exemplary container 32 has individual compartments 38a-38g representing the days of the week; Monday through Sunday. Each of the compartments 38a-38g is closed by a separate repositionable lid 40a-40g. Different medications are divided up into the compartments 38a-38g depending upon the quantity of doses, if any, for each of the days of the week.

The containers 34 and 36 differ from the container 32 by further designating “AM” and “PM” on the lids for the days of the week. This allows a better degree of control over timing of taking of the medication in a given day.

The problems associated with use of the containers 32, 34, 36 are described in the Background portion herein.

According to one form of the invention, the existing container 10 may be modified as shown in one form at FIG. 8. Generic information 42 is applied to the container 10 to supplement the information 26 applicable to the specific medication 12 therein. If the generic information 42 is applied partially or fully upon the closure/cap 24, an appropriate tether 44 is preferably utilized to maintain the closure/cap 24 in association with the body 14 with the medication 12 to which the generic information 42 on the closure/cap 24 specifically applies. Typically, the closure/cap 24 does not have any information relating to the medication thereon. Thus, the application of the generic information 42 to the closure/cap 24 is in itself novel. The closure/cap 24 provides a convenient location for an individual to identify the generic information 42 without perusing the information 26.

As shown in FIG. 9, with the generic information 42 provided at least partially upon the body 14, it may be applied to the peripheral wall 20 and/or the bottom wall 18.

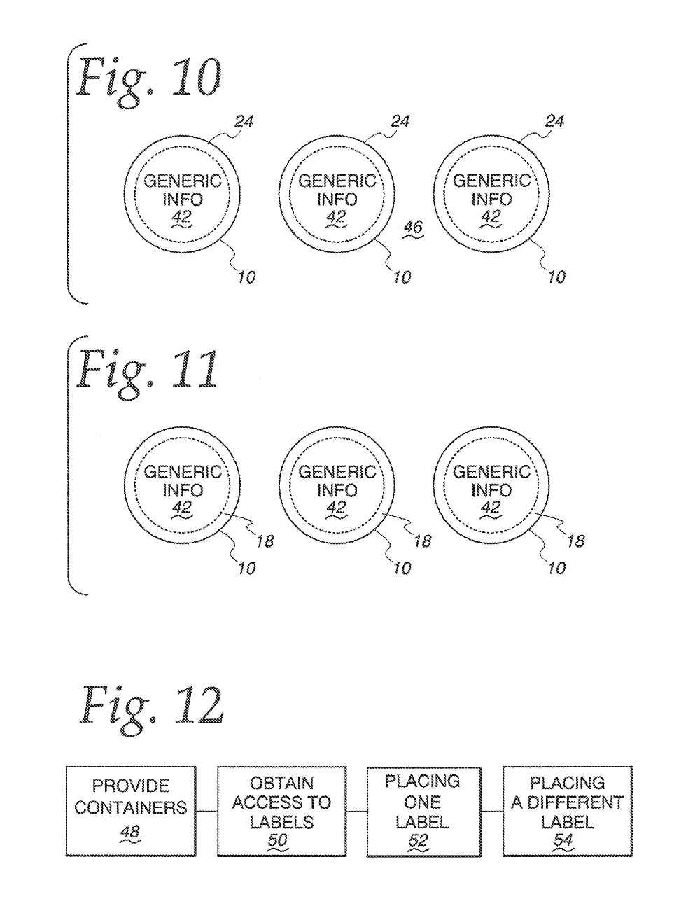

In FIG. 10, one method of applying the generic information 42 is shown wherein the generic information 42 is provided on the cap 24 of different containers 10 with different medications therein. Accordingly, with the containers 10 remaining upright, the individual taking the medication may line the containers 10 in an upright orientation on a subjacent support 46 and clearly see the generic information 42 at the same location on each container to obtain information as to at least one of: a) when to take the medication; b) how many doses of the medication in the container are to be taken; and c) how to take the medication in the container.

In FIG. 11, an alternative form of the invention is shown wherein the generic information 42 is applied in the same location at the bottom wall 18 of the containers 10. With the containers 10 upright, the individual can lift or tip the containers 10 to allow viewing of the generic information 42 consistently at the same location.

In the event that the generic information 42 is in the form of printed words and/or abbreviations, the letters are preferably significantly larger than the letters for the non-generic information 26 so as to be dominantly visible compared to the non-generic information 26. Thus, an individual is allowed to readily make a determination as to whether, how much, and how to take a particular medication. This potentially can be done by a quick glance. Preferably, the lettering of the generic information 42 is at least 2-3 times the lettering size for the non-generic information 26 so as to allow an individual to make a quick determination as to when, how much, and how to take the particular medication in the inspected container.

As shown in FIG. 12, in flow diagram form, the invention may be practiced by performing a series of steps to prepare medications to be taken by an individual. As shown at block 48, multiple containers are provided. As shown at block 50, access is gained to a supply of labels having generic information thereon to advise an individual at least one of: a) when to take medication in the container; b) how many doses of medication in the container are to be taken; and c) how to take medication in the container. The supply of labels is made up of at least a first label wherein the generic information thereon is applicable to the taking of a first medication by the individual and is different than the generic information the second label in the supply of labels that is applicable to the taking of a second medication by the individual. As shown at block 52, the first label is placed on the first container. As shown at block 54, the second label is placed on the second container.

Generally, the non-generic information will be provided in addition to the generic information on first and second containers containing different medication. However, this is not required.

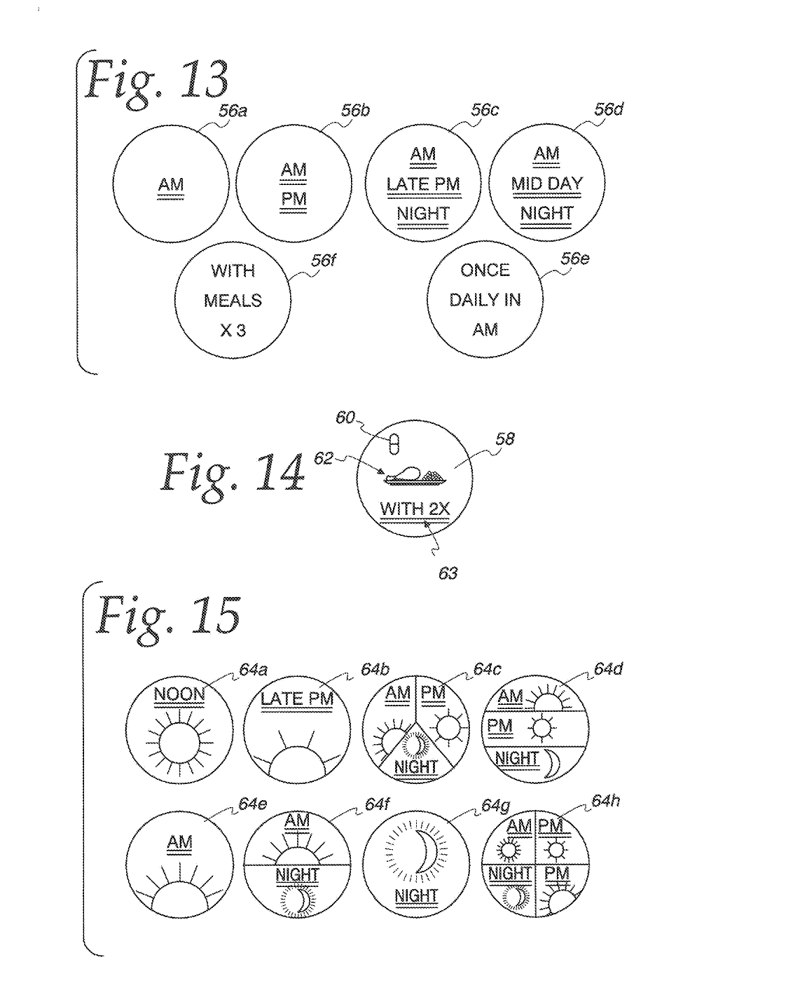

Exemplary labels of a first type are shown in FIG. 13 at 56a-56f. The label 56a identifies a dosage to be taken in the AM. Label 56b identifies a dosage to be taken in both the AM and PM. Label 56c identifies a dosage to be taken in the AM, late PM, and at night. Label 56d identifies dosages to be taken in the AM, mid-day, and at night. Label 56e identifies dosages to be taken one time daily in the AM. Alternatively, the instruction may relate to the taking of multiple dosages. Label 56f identifies a dosage to be taken with each of three meals. The information may identify a different number of dosages to be taken with one, two and/or three meals.

In FIG. 14, a label is provided at 58 that provides information in the form of pictorial representations that visually convey at least some of the necessary information to the individual. As seen at 60, there is a pictorial representation of a pill, with a pictorial representation of a meal shown at 62. At 63, there is generic wording to identify dosage indicating number of pills to be taken with each meal and/or number of meals at which pills are to be taken.

In FIG. 15, there are labels 64a-64h with information in the form of pictorial representations and words/abbreviations. In each case, either the word/abbreviation or pictorial representation may be used to the exclusion of the other. For example, label 64a shows a pictorial representation of a full sun, representing noon/midday. The label 64a might just have the “noon” designation or the pictorial representation thereof without the word “noon”.

Label 64b shows a red/orange setting sun with the designation “late PM”.

Label 64c shows abbreviations and pictorial representations for AM, PM, and night. The AM pictorial representation is a yellow rising sun, with the yellow midday sun representing PM, and a silver moon representing night. Label 64d shows the same representations and words/abbreviations in a different pattern.

Label 64e shows a yellow rising sun and the designation “AM”.

Label 64f shows the yellow rising sun and a silver moon, respectively with “AM” and “Night” designations.

Label 64g shows a silver moon and the designation “Night” or “Bedtime”.

Label 64h shows words/abbreviations and pictorial representations for “AM/Noon/Late Afternoon” or “PM” and “Night” designations.

All of the words and pictorial representations are just exemplary of what might be utilized. An appropriate and logical system of words, abbreviations, and pictorial representations may be devised that departs from the details depicted but uses the basic concepts described herein. In each case, it is desirable that an individual be able to identify the generic information without the requirement to read a large amount of information and potentially with a simple glance at the generic information that is conveyed through the words/abbreviations and/or pictorial representations.

For example, with the arrangement of components as in FIG. 11, an individual may simply tip/lift the containers 10 and quickly glance at the generic information 42 to make a determination as to whether to take a medication, how many doses (if any) to take, and how to take the medication in the particular container.

One objective of the present invention is to simplify and greatly reduce the time needed for patients to accurately take multiple medications up to several times per day. By using the invention, the time-consuming task of loading containers as in FIGS. 5-7 is avoided.

Preferably, conventional containers with conventional labelling (the ubiquitous brown plastic pill bottle with a white cap) need not be changed in any material way. The various labels can be applied at any time, and potentially after the conventional container is in its normal state for delivery to an individual purchasing the medication. The labelling can be applied at a pharmacy or at an individual's home or preferably with the assistance of someone that can avoid misapplication of information.

The aforementioned labels might be applied using adhesive, such as a pressure sensitive adhesive 66 as shown on the exemplary label 58 in FIG. 14.

As an alternative to using labels, container bodies may be impressed with the generic information in the form of words/abbreviations and/or pictorial representations. Direct printing on an existing container is also contemplated.

Regardless of precisely how the generic information is applied, a patient is allowed to arrange containers on a convenient surface, such as a table, desk, windowsill, etc. With a mere glance, he/she can know which pill container to take a dose from, depending upon the time of day. Potentially great time is saved, the medication is taken at the proper time of day, and by moving the containers to a different position after each dose is taken, the individual is able to conveniently follow a doctor's instructions with speed and efficiency.

Also, because the container is in its original filled state minus a pill for each timed dose, it is easy to go back and find if any dosing errors have been made. There is no preparation of medicines needed—just the bottle placed on any convenient surface and observed by the patient two, three, or four times per day; whatever their dosing schedule is.

The foregoing disclosure of specific embodiments is intended to be illustrative of the broad concepts comprehended by the invention.

1. A medication storage system comprising:
a container for a medication to be taken by an individual; and
information on the container to advise an individual at least one of: a) when to take medication in the container; b) how many doses of medication in the container are to be taken; and c) how to take medication in the container,
the information comprising at least one pictorial representation that visually conveys at least some of the information to the individual.

2. The medication storage system according to claim 1 wherein the container has a top opening and a bottom wall and the information is provided on the bottom wall.

3. The medication storage system according to claim 1 wherein the container has a top opening and a closure for the top opening and the information is provided on the closure.

4. The medication storage system according to claim 1 wherein the information comprises one of words and abbreviations.

5. A container for medication to be taken by an individual, the container comprising:
a body defining a storage space for medication and having a bottom wall, a peripheral wall, and an opening for introducing medication into the storage space and removing medication from the storage space;
a closure that is changed between a closed position wherein the closure blocks the opening and an open position wherein medications can be directed through the opening into and from the storage space; and
information provided on at least one of the bottom wall and closure to advise an individual at least one of: a) when to take medication in the container; b) how many doses of medication in the container are to be taken; and c) how to take medication in the container.

6. The container for medication to be taken by an individual according to claim 5 wherein the information comprises at least one pictorial representation that visually conveys at least some of the information to the individual.

7. A method of preparing medication to be taken by an individual, the method comprising the steps of:
providing first and second containers respectively having first and second bodies defining first and second storage spaces within which first and second different medications are placed;
obtaining access to a supply of labels having generic information thereon to advise an individual at least one of: a) when to take medication in the container; b) how many doses of medication in the container are to be taken; and c) how to take medication in the container,
the supply of labels comprising a first label wherein the generic information thereon is applicable to taking of the first medication by the individual and is different than the generic information on a second label in the supply of labels that is applicable to taking of the second medication by the individual;
placing the first label on the first container; and
placing the second label on the second container.

8. The method of preparing medication to be taken by an individual according to claim 7 further comprising the step of placing non-generic information relating to the first medication on the first container in addition to the generic information on the first label.

9. The method of preparing medication to be taken by an individual according to claim 8 wherein the generic information on the first label and the non-generic information on the first container each comprises letters making up at least one of words and abbreviations and the letters in the generic information on the first label are larger than the letters making up the non-generic information on the first container.

10. The method of preparing medication to be taken by an individual according to claim 9 wherein the step of placing the first label on the first container comprises applying the first label through an adhesive.

11. The method of preparing medication to be taken by an individual according to claim 10 wherein the step of placing the first label on the first container comprises applying the first label through a pressure sensitive adhesive.
